(19) United States
(12) Patent Application Publication
(10) Pub. No.: US 2004/0249919 A1
(43) Pub. Date: Dec. 9, 2004

(54) System and method for remote systems management and reporting

(76) Inventor: Dirk Mattheis, Chicago, IL (US)

Correspondence Address: KRAMER LEVIN NAFTALIS & FRANKEL LLP, INTELLECTUAL PROPERTY DEPARTMENT, 919 THIRD AVENUE, NEW YORK, NY, 10022, US

(21) Appl. No.: 10/455,749

(22) Filed: Jun. 4, 2003

(51) Int. Cl. G06F 15/173; G06F 9/44; G06F 9/445

(52) U.S. Cl. 709/223; 717/171; 717/176

(57) ABSTRACT

A system and method are presented for a low cost and efficient remote systems management tool. In exemplary embodiments of the present invention a system environment includes the installation of a small software component on each client device. These components work in conjunction with one or more distributed and/or centralized support servers to obtain software updates, and then execute a series of software modules. In contrast with conventional systems, since neither dedicated servers nor specialized scripting languages are required, a system according to an embodiment of the present invention can leverage industry standard technologies. Thus, in exemplary embodiments of the present invention support servers can be, for example, existing file/print servers running on a local area network or secure FTP servers which are hosted either inside or outside of an enterprise LAN environment. Additionally, such a system can be coded in readily available scripting languages. Thus, in an exemplary embodiment of the present invention designed to manage client devices running MS Windows™ systems, the system can be coded in, for example, WinBatch™.

### TECHNICAL FIELD

The present invention relates to hardware and software monitoring, maintenance and management. More particularly, the present invention relates to a system and method for the remote management and maintenance of a highly distributed global computing environment.

### BACKGROUND INFORMATION

Within most global enterprises, mobile computing has been steadily increasing in both popularity and numbers over the past several years. Industry analysts have predicted that this trend will continue for the foreseeable future. As the numbers of mobile computers increase, the challenge of managing and maintaining these systems does as well. Most global information technology (“IT”) support resources do not now have a single comprehensive toolset which can provide a seamless support link between these dispersed resources and a company's IT support team.

Conventional software tools exist which support global software and hardware management, such as, for example, IBM's Tivoli™, as well as similar products provided by Computer Associates and Hewlett-Packard. However such conventional systems have numerous drawbacks. Because they are designed to integrate into other more complex toolsets and proprietary reporting and management resources, they tend to be complex themselves. Moreover, conventional system management tools require a dedicated server infrastructure running proprietary software. Implementing these tools thus requires a substantial investment in hardware and software, and forces a company utilizing them to dedicate a team of trained experts to operate the environment.

Because conventional systems management environments require a dedicated server infrastructure, each client must be continually connected to a master server. Two drawbacks are inherent in this approach. First, the client-side software cannot operate independently; if there is no connection to the master server, it cannot perform any function. Second, the conventional management system continually runs as a process or service on each distribution server, completely controlling the client. This requires network bandwidth to be dedicated to the management system.

On the other hand, there are management environments supplied by vendors of a particular product, such as, for example, anti-virus software, that allow for that particular product to be updated throughout a network without the expensive dedicated infrastructure of conventional system management tools. These updates are generally distributed via ftp or equivalent file sharing protocols, and do not require a dedicated infrastructure with processes continually running on dedicated management servers. However, inasmuch as these software management environments only support one particular product, they cannot be used as an “open source” or overall system management tool to provide updates and support for all client applications. Users cannot write scripts which these environments will run. Moreover, they have no facility for tracking all computing assets within an enterprise.

What is needed in the art is a simple, low cost and effective tool that can facilitate the accurate tracking of each and every computing asset on a network and ensure that those resources remain safe, secure and updated with the most recent application and support software available, without requiring a complex and proprietary dedicated server infrastructure and the associated software.

### SUMMARY OF THE INVENTION

A system and method are presented for a low cost and efficient remote systems management tool. In exemplary embodiments of the present invention a system environment includes the installation of a small software component on each client device. These components work in conjunction with one or more distributed and/or centralized support servers to obtain software updates, and then execute a series of software modules. In contrast with conventional systems, since neither dedicated servers nor specialized scripting languages are required, a system according to an embodiment of the present invention can leverage industry standard technologies. Thus, in exemplary embodiments of the present invention support servers can be, for example, existing file/print servers running on a local area network or secure FTP servers which are hosted either inside or outside of an enterprise LAN environment. Additionally, such a system can be coded in readily available scripting languages. Thus, in an exemplary embodiment of the present invention designed to manage client devices running MS Windows™ systems, the system can be coded in, for example, WinBatch™.

### BRIEF DESCRIPTION OF THE DRAWINGS

FIG. 1 depicts an exemplary operational topology according to an embodiment of the present invention;

FIG. 2 depicts exemplary support of remote users according to an embodiment of the present invention;

FIG. 3 depicts an exemplary system server co design according to an embodiment of the present invention;

FIG. 4 depicts an exemplary software distribution schema according to an embodiment of the present invention;

FIG. 5 is a process flow diagram for an exemplary client-side implementation according to an embodiment of the present invention;

FIG. 6 is a process flow diagram for an exemplary core engine according to an embodiment of the present invention;

FIG. 7 depicts an exemplary information delivery pathway according to an embodiment of the present invention;

FIG. 8 depicts a more detailed example information delivery system according to an embodiment of the present invention;

FIG. 9 depicts an exemplary client device user interface according to an embodiment of the present invention;

FIG. 10 depicts an example client status window according to an embodiment of the present invention;

FIG. 11 depicts an example client status window according to an alternative embodiment of the present invention;

FIG. 12 depicts an example asset information query screen according to an embodiment of the present invention;

FIG. 13 depicts an example asset query result screen according to an embodiment of the present invention;

FIG. 14 depicts an alternative example asset query result screen according to an embodiment of the present invention;

FIG. 15 depicts an example system detail information screen according to an embodiment of the present invention;

FIG. 16 depicts an example asset information detail screen according to an embodiment of the present invention;

FIG. 17 depicts an alternative example of an asset information detail screen according to an embodiment of the present invention; and

FIG. 18 depicts an example active statistics report interface screen according to an embodiment of the present invention.

### DETAILED DESCRIPTION OF THE INVENTION

The present invention facilitates the remote management and tracking of all of an enterprise's hardware and software assets. In so doing, a system and method are presented for an automated client-side hardware and software management system that operates without dedicated management servers and does not require continual connections between client-side software and a management host. In an exemplary embodiment of the present invention the method further provides for management data to be collected locally at a client and sent via email to a central system server where it is automatically input to a database.

In an exemplary embodiment of the present invention, software code stored locally on a client device automatically runs in response to defined events and performs a variety of information technology (“IT”) asset management tasks. Included in such tasks can be, for example, detecting the client device's operating system and version and the path to various directories, opening an activity log, detecting the language and type of operating system and Internet browser, getting client device user details, determining the network environment, checking level of connectivity, determining the nearest management system host, determining the location and IP address of the client device, checking if the management and application software is up-to-date, accessing updated software from a management system host, software installation, diagnostic and preventive maintenance services, device and network security management and dynamic asset management and reporting.

In exemplary embodiments of the present invention, management software stored on a client device has a modular structure, with a main or top level program called a “core” and a series of application modules which the top level program executes called “plug-ins,” as described more fully below. Between the core code and the various plug-ins, management software can perform a wide variety of tasks. In exemplary embodiments of the present invention the management software can be launched at logon, after a defined time period, after a connectivity change, after the occurrence of a defined event, or in response to other system defined parameters or events.

For clarity of illustration, a system according to the present invention will be sometimes referred to herein as “SMART” (System Management and Reporting Tool), a name given the system by its inventor and which appears in many of the drawings presented herewith.

SMART Features

In exemplary embodiments of the present invention SMART can provide the following general functionalities:

Software Installation and Update services: Installation of new applications, distribution of application patches and fixes, installation of updated data files, uninstallation/reconfiguration services and direct registry edits and updates.

Diagnostic and Preventative Maintenance services: Local disk defragmentation check and repair, local disk size/free disk space status with low space alerting, Outlook™ PST size checking: 700 MByte first level warning, 1.5 GByte second level warning. (A PST file is a Microsoft Outlook™ data file (personal folder storage file) which holds mail, calendar, contacts, etc. items on the local hard disk. Its size is limited by the operating system to 2 GBytes. Since the maximum size is not enforced by either the operating system or Outlook™, data loss can occur if its size exceeds 2 GBytes. SMART monitors the size and provides a warning feature to users).

Device and network security management: Provision of pro-active NT domain password change reminders, remote system or component disable/system recall capacity, home office/last office connectivity and asset tracking information, flexible investigative functions (e.g., file search, application search, etc.), OS versioning and SP tracking. (Operating system (“OS”) versioning refers to tracking the operating system version including the service pack (“SP”) level. For example, every 18-36 months-Microsoft releases a major operating system (such as Windows 95™, Windows 98™, Windows 2000™, or Windows XP™) and every 9-15 months it releases a service pack which is used to update a given OS to the most recent patch level. Thus, proper tracking of the OS and SP is required to report any security risks caused by missing updates).

Dynamic Asset Management and Reporting: Device home location, device last connection location, dynamic device configuration information (including dynamic data links to device manufacturer's data), interactive asset information (lease information, device implementation date, lease term date, serial number, device model number), installed RAM identification, initial RAM identification, processor type and clock speed identification, device manufacturer and complete model number identification, web delivered asset tracking reporting gateway with pre-defined reports, web delivered real time tracking information interface, application license tracking, client SMART status report window, network connection times including rolling percentages, and network connection type tracking.

For ease of illustration herein, exemplary embodiments of the present invention will be described herein in terms of the following model. An enterprise or company operates globally. As a result, the company has numerous computer (hardware and software) assets distributed across the globe as well as numerous computer communications networks. The company has numerous local area networks connecting the devices within a particular site or company installation, as well as a global wide area network. In addition, employees of the company can also connect to one or more company networks remotely, using the Internet or other communications pathways. Thus, exemplary embodiments of the present invention are designed to also support operation over limited bandwidth connections, such as, for example, a wide area network (“WAN”), a virtual private network (“VPN”), and analog remote services. It is understood that this illustrative model is only exemplary, and the invention can be implemented over a wide variety of computing topologies.

In exemplary embodiments of the present invention, users of client systems in a company facility anywhere on Earth can have SMART functionality. In preferred exemplary embodiments of the present invention, the presence of SMART on a client machine is automatically checked any time a machine logs onto a company domain, thus ensuring that the company has the ability to use SMART to track any device connected to a company network. When a user connects to a company network segment, SMART activates. Initially, SMART determines where the user is, and subsequently, where the nearest SMART host is. Within a few seconds, a SMART tool can activate on the client device and begin its operations. Should updates or downloads be required, they can be transferred via a local LAN infrastructure from a local SMART host. No dedicated SMART host servers are required. This is because SMART can leverage local file/print devices (or any device capable of file sharing via UNC or FTP, as described below) to operate as a SMART host.

Software Distribution Topologies

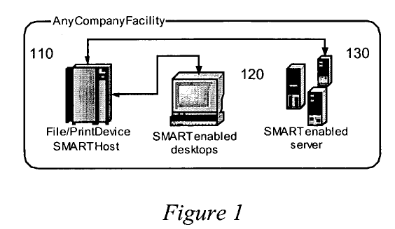

FIG. 1 depicts an example SMART operational office topology according to an exemplary embodiment of the present invention. With reference to FIG. 1 a file/print device is used as a SMART host 110; the SMART host 110 is connected to SMART-enabled desktops 120 as well as a SMART-enabled server 130.

Designed to operate over limited bandwidth connections including, for example, WAN, VPN and analog remote services, SMART follows a simple but intelligent operations model. Users with systems in any company facility anywhere on earth have SMART functionality. When a machine logs onto a company domain, in exemplary embodiments of the present invention, there is an automatic check for the presence of SMART, thus ensuring that a company has the ability to use SMART to track any device connected to its network. When a user connects to an company network segment, SMART activates, as next described.

SMART first determines where the user is and where the nearest SMART host is. Within a few seconds, SMART can activate and begin operation. Should updates or downloads be required, they can be transferred to the user's computer via a local LAN infrastructure from the local SMART host. SMART hosts are not dedicated machines. As noted, they can be any device able to share files via Universal Naming Convention (“UNC”) and/or File Transfer Protocol (“FTP”). Thus, for example, local existing file/print devices can be leveraged as SMART hosts.

Because many users frequently operate disconnected from their company's private network, SMART also supports Internet accessibility. In an exemplary embodiment of the present invention any SMART enabled device that connects to any network that includes Internet connectivity can remain actively managed and updated by SMART. This can be accomplished as follows. A secure Internet FTP server can be maintained by the system. Such a server would, in general, be password protected and inaccessible to the general public. Within the client-side SMART code the IP address of this server (and access password) can be stored (and, if needed, updated via SMART, as described below). Thus, whenever a company device connects to the Internet, SMART can see the connection and direct the device's browser to the company Internet server.

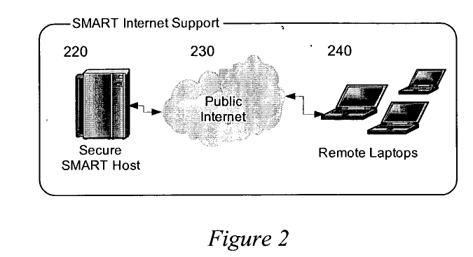

Thus, SMART management is available whenever a company asset is connected to a company network, an employee's home broadband connection or even when a company device is connected in a hotel or airport. This extended connectivity also facilitates sophisticated asset tracking capabilities inasmuch as SMART does not require a connection to a company private network to activate and function. As noted above, to support Internet connectivity a dedicated, secure SMART FTP host can be provided on a company's extranet infrastructure. Such an exemplary design is depicted in FIG. 2, where a secure SMART host 220 is connected to the Internet 230, to which in turn is connected a number of remote laptops 240.

Maintaining a distributed network of SMART hosts can also be done automatically, using SMART server scripts. When updates are placed on a central or master SMART host, for example, in a company network center, such updates can be automatically pulled by every distributed SMART host during non-office hours (thus not competing with business tasks for available bandwidth). Additionally, in an exemplary embodiment of the present invention a company can manually activate the SMART distribution process in the event that emergency situations ensue, such as, for example, urgent virus definition updates becoming available, etc.

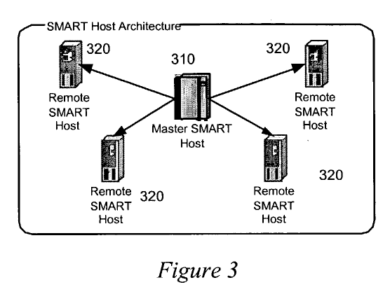

An example SMART server communication topology is depicted in FIG. 3. With reference thereto, a master SMART host 310 is connected to a plurality of remote SMART hosts 320. As noted above, software updates and/or updates to the SMART code itself can be placed on the master SMART host by, for example, IT personnel in a company network center. Such updates can then be pulled by remote SMART host 320 during off-hours.

Connectivity Levels and Software Distribution

Connectivity levels and software distribution mechanisms according to exemplary embodiments of the present invention will next be described. As noted, exemplary embodiments of the present invention are designed to operate over limited bandwidth connections, such as, for example, WAN, VPN, and analog remote services, as well as high bandwidth company LANs. As a result, in exemplary embodiments of the present invention a simple but intelligent operations model is followed.

In an exemplary embodiment of the present invention SMART can classify different connectivity types to determine the best method of processing any downloads or installations that may be required. Such connectivity types can be, for example, the following, with their associated update receipt levels:

LAN—A client is connected to a Local Area Network (LAN) in a company office location. The client gets all mandatory updates.

VPN—A client is connected via a Virtual Private Network (VPN) client to the company Wide Area Network (WAN). The client gets smaller updates (up to ˜5 MBytes) from a central server.

DUN—A client is connected via Dial-Up Networking (DUN) to the company WAN, either via corporate analogue remote access or via an Internet Service Provider (ISP) and the VPN client. Only small updates can be uploaded (exception: antivirus engine and signature updates if necessary).

ISPLAN—A computer is connected via a LAN to a private ISP. It has access to public resources on the Internet but not to resources on a company WAN. No updates would get uploaded in this situation (exception: antivirus engine and signature updates from an external secure FTP site).

ISPDUN—A client is connected via a DUN to a private ISP but has no connection to a company WAN. No updates would get uploaded (exception: antivirus signature updates from an external secure FTP site).

OFFLINE—A client has no or no usable connection to the Internet or to a company network. SMART will prompt the user to connect as soon as the antivirus signatures become older than eight days.

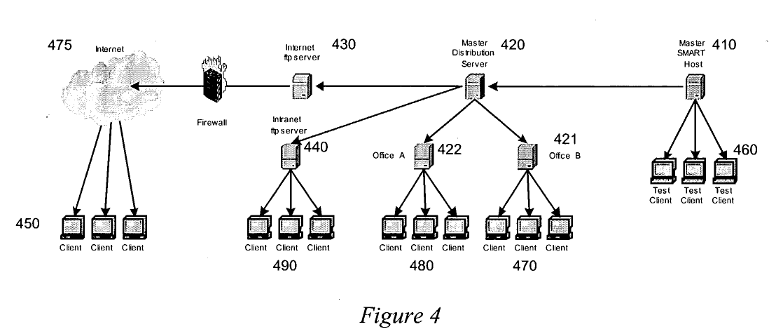

FIG. 4 depicts an example of various connections that a client device can have to the SMART system according to an embodiment of the present invention. With reference to FIG. 4, a master SMART host 410 is the source of all SMART code. In the depicted example, master SMART host 410 is directly connected within a company test lab to a number of test clients 460. Master SMART host 410 is also connected to a master distributor server 420, itself connected to office servers 421 and 422. Office servers 421 and 422 are analogous to the remote SMART hosts 320 depicted in the exemplary embodiment of FIG. 3. Each of the office servers 421 and 422 are connected to a number of client devices 470 and 480, respectively. Additionally, master distributor server 420 is connected to an intranet FTP server 440, to which are connected a number of clients 490. Unlike the clients of office servers 421 and 422, intranet clients 490 are not connected to a company local area network, and thus have lower bandwidth connections. Finally, master distributor server 420 is also connected to an intranet FTP server 430, which is connected, across a firewall, to the Internet 475 to which are also connected Internet-connected clients 450.

As described above, the various connectivity pathways depicted in FIG. 4 correlate to various levels of software distribution from the master SMART host 410. Test clients 460, as well as clients 470 and 480, all of whom are connected to host 410 via a local area network, can get all pending updates, such as, for example, service packs, new software releases, etc., from their LAN-based UNC remote SMART host 421 or 422. If a client device is connected to a company intranet, such as clients 490, but not connected via a local area network, such clients can get pending security updates, such as, for example, new virus definitions, as well as smaller software updates from internal FTP servers. However, such intranet-connected clients 490, not being connected to a LAN host, cannot receive all of the pending updates. Moreover, if a client 450 is connected across the Internet via Internet FTP server 430, such clients can get pending security updates from secure FTP servers such as 430, but nothing more.

Finally, if a client device is off-line, locally-resident SMART code can prompt the user to get scheduled security updates. The locally-resident SMART code can do this, for example, by accessing the client device's internal clock, and knowing the company's predetermined schedule of security updates, such as for example, every eight days. SMART code can thus monitor when a security update is scheduled and prompts a user to connect.

The location finding and self-updating functionalities of the present invention will next be described. In an exemplary embodiment of the present invention a core SMART engine can detect if a location change has occurred, as well as the current location of a client device. Once that has been accomplished, the core engine can locate a nearest distribution share (also referred to herein as a remote SMART host) and determine whether any updates are available. If so, an update engine updates “plug-ins” and then executes the plug-ins, as detailed below.

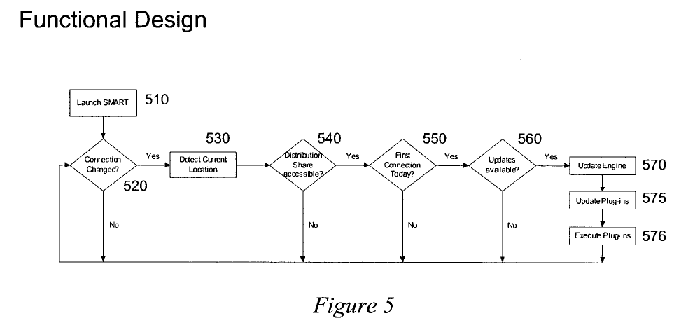

FIG. 5 depicts an exemplary continuous process loop that can be executed by SMART on a client device. Starting at 510 SMART is launched, and at 520 SMART decides (by accessing appropriate flags and/or registers on the client device) whether a connection has changed, such as, for example off-line to dial-up, or virtual private network to company LAN. If yes, at 530 SMART detects the current location of the client device. This can be done, for example, by accessing the IP address of the client device from appropriate registers, using either DOS batch commands, or, for example, in newer Windows™ based systems via the Windows Management Interface™, or “WMI.” Once the current location is known, at 540 SMART determines whether a distribution share (remote SMART host) is accessible by trying to access certain default files on the share. If yes, at 550 SMART determines whether this would be the first connection on that particular day.

If yes, at 560 SMART determines whether updates are available. This can be done, for example, by accessing the internal clock and determining whether the date/time stamp of current versions of application code running on the client device are older than a predetermined update interval. If yes, at 570, an-update engine can be launched. At 575 the update engine updates “plug-ins” (described below) and at 576 executes them, returning afterwards to 520 for another cycle. In this manner, SMART can continually monitor location changes and the current location of the client device.

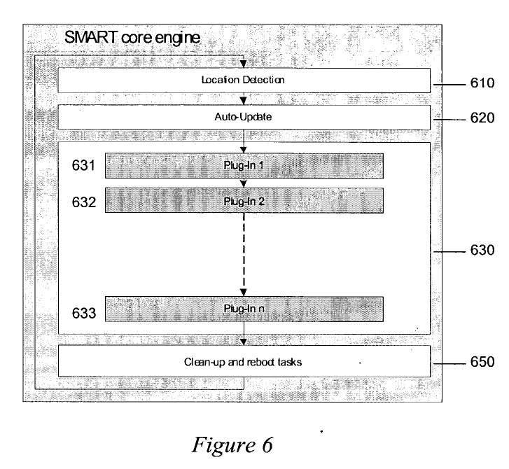

“Plug-ins”, as used herein, are pieces of compiled code which carry out dedicated tasks. As next described in connection with FIG. 6, according to an exemplary embodiment of the present invention, various plug-ins are provided in exemplary embodiments of the present invention. This allows for modularity, where any number of plug-ins can be used with the SMART system. New plug-ins are independently created and compiled and then merged with the overall SMART code. Plug-ins, like core SMART code, can be written in a variety of industry standard scripting languages, using techniques known in the art.

SMART Plug-Ins

In exemplary embodiments of the present invention, SMART supports a plug-in architecture. New features can be added, removed, or disabled simply by manipulating the plug-ins on a client device. Plug-ins can be manipulated remotely via the core SMART engine.

As noted, plug-ins are simply small parts of compiled code. Plug-ins can be executed on the fly when SMART runs. Plug-ins tend to be small files. For example, in an exemplary embodiment of the present invention the main SMART application code occupies approximately 1 MByte in size, and plug-ins in such exemplary embodiments occupy from 3 to 50 kilobytes. Plug-ins allow system administrators to perform various desired activities by deploying small pieces of code which are automatically downloaded to a client device and executed locally.

Using SMART's plug-in architecture, in a preferred exemplary embodiment of the present invention SMART can be implemented to manage a distributed server infrastructure as well (as opposed to only managing end-user client devices). In such an exemplary embodiment, SMART can keep server virus definitions updated and provide configuration, service pack installation and update capabilities on servers as well as workstations, desktops, and other client devices.

According to an exemplary embodiment of the present invention, SMART can support the following primary plug-ins. Example names are provided with a functional description of each plug-in.

BRIGHTSTOR: Configures a CA Brightstor mobile backup service client and provides reporting capabilities when required on workstation data types and sizes.

CONFIGIE: Provides dynamic monitoring and configuration of MS Internet Explorer browser clients.

CONFIGPAL: Pushes phone book updates for WorldCom™ PAL remote access client environment. Also configures and updates the configuration of the PAL client.

CONFIGVPN: Configures and manages user VPN client software.

CONFIGW2K: Provides capacity to deliver service packs, hot fixes and dynamic configuration of Windows 2000™ and Windows XP™ systems. This plug-in also forces users to change their local administrative passwords, and provides advance warnings of pending password change events as well as other services.

DISABLEBM: Disables the Windows™ browse master service on client systems.

ETRUST: Manages and delivers virus definition updates and code updates to CA eTrust™ virus defense clients.

EXTENSITY: Provides remote software management, patch installation and remote configuration of the Extensity time and expense management application.

FONTUPD: Updates system fonts and helps manage changes and installation of new system fonts required by a company such as HARVEYBALL, etc.

ITAUDIT: Collects and reports asset tracking information for all systems.

OFFICE2K: Performs remote management of Office 2000 client environment. Also checks file sizes of PST files, providing warnings to user when PST files reach 700 MB, then stronger warnings again at 1.5G. (eliminates 2G file corruption problem)

PCTUNEUP: General plug-in that checks drive fragmentation (activates defrag if needed), checks available drive space, routinely cleans up temp spaces and files, prompts users to perform backups, etc.

SUPPORT: Provides ability to dynamically update the system support information displayed in the systems properties of Windows™ clients. Allows for update of support phone numbers, locations, etc.

VSC45UPD: Manages and delivers virus definition updates and code updates to

McAfee™ VirusScan™ virus defense clients.

WIRELESS: Installs and manages the wireless NIC drivers installed on company Windows 2000™ systems.

SMARTSDL: SMART activity scheduler, runs only on Windows 2000™ and Windows XP™ systems to increase reliability of updates, also actively runs in the background to determine network status and monitors for changes in connectivity status.

Additional plug-ins can be created, distributed, deactivated or uninstalled as may be needed or desired in various embodiments of the present invention. Typically, simple plug-ins for emergency updates, user notifications, special asset or configuration checks can be created within twenty-four hours. Other more complex plug-ins that distribute, install and configure. new application clients can, for example, take up to seven days to create and test.

To illustrate how plug-ins are executed, with reference to FIG. 6, process flow within an exemplary SMART core engine is depicted. At 610, SMART determines the location of the client. At 620 SMART implements an auto-update where it (i) first checks whether or not the core engine needs to get updated (core engine size, in exemplary embodiments, is between 100 KBytes to 1 MByte, depending upon changes applied to the core engine); and (ii) then checks whether or not its plug-ins are outdated (adds new, updates existing, and removes redundant plug-ins).

Subsequent to auto-update, at 630 plug-ins 1 through N are run. The number N of plug-ins is set by system administrators, and SMART can accommodate as many as might be practically desired. As noted above, plug-ins are small compiled scripts which can be launched in succession by a SMART core engine. Plug-ins can be developed independently and then tested as part of the entire SMART tool kit. Moreover, in preferred exemplary embodiments of the present invention, there can be made available different plug-ins for various departments or domains within a particular organization. Thus, for example, if a particular company or organization has two or more intracompany domains, and a certain set of client devices is exclusively assigned to each domain, based on the knowledge of the IP addresses of the devices assigned to each domain, SMART can access, as part of the auto-update process 620 the plug-ins specific to a particular client device. For example, if one domain is running Windows XP™, and another domain is running Windows NT™, and there are updates of certain applications which run under both operating systems (e.g., MS Word™) but which have slightly different update modules.

After all plug-ins have been run, at 650 the SMART core engine implements clean-up and reboot tasks and returns to 610.

SMART has built-in capabilities to update itself and it can use other applications on a client's hard disk to perform certain activities. This makes it possible to deploy updates without the intervention of local support staff, and guarantees that updates get installed on all systems. Since SMART knows where a given user is located (e.g., by determining the IP address of the system) and how the system is configured, (e.g., by reading the pertinent registers), it can detect if an update is available or whether or not it is time to prompt the user for a manual update.

The SMART Client

The SMART Client is the client device resident core code. It is analogous to a “main” function in high level programming languages, and it controls the activities of SMART on the client. As described in more detail below, the SMART Client performs the administrative/logistical functionalities such as location detection, nearest distribution share location detection, level of connectivity detection, auto-update, plug-in update, etc. Having performed such functions the SMART Client then launches the plug-ins in sequence, and cleans up and reboots in preparation for another SMART cycle. In exemplary embodiments, SMART can be located in a Windows™ program files directory and started after each logon. Alternatively, as illustrated in the example of FIG. 5, SMART can check every five (or other desirable number of) minutes whether or not a usable network connection is available and determine if it is necessary to start SMART.

There are several tasks that can be performed by SMART during each cycle. In an exemplary embodiment of the present invention, such tasks can include the following:

Detect version of Windows™ and path to Windows™ directory;

Check if launched with optional parameter;

Open an activity log;

Detect the language of OS and IE;

Get User details (User Name, First/Last Name, Home Office, . . . );

Get network environment;

Check if computer is connected to a company LAN, company VPN, company DUN, an ISPLAN, an ISPDUN or is OFFLINE;

Determine local distribution share (e.g. on local File/Print server);

Check if SMART is up-to-date, if not auto-update;

Check if Plug-ins are up-to-date, if not synchronize with SMART update host

Execute all plug-ins; and

Prompt for reboot or force reboot depending on flags returned by plug-ins;

Due to the fact that SMART is able to detect the client's current location it can determine whether or not an update is either necessary and/or possible (inasmuch as due to a low bandwidth connection the only available updates may not be possible) and exit as early as possible. This reduces the load on a client device and frees up resources for other applications.

In an exemplary embodiment of the present invention SMART can track its activities with its own log files. Because it is sometimes necessary to see what happened prior to the last SMART launch, in an exemplary embodiment of the present invention SMART keeps an incremental backup of the last SMART log file.

In a preferred exemplary embodiment of the present invention, a SMART implementation designed to run on Windows 2000™ Professional computers can be configured. This embodiment contains the SMARTSDL plug-in described above and can maintain its own log files which can be called, for example, “SMARTSDL.log.” Such a log file can contain, for example, the last 10 cycles of the SMARTSDL plug-in, which permanently runs in the background. As noted above, it can also continually check the current connection type at five (or other convenient number of) minute intervals and decide whether or not to launch SMART to carry out certain tasks.

Thus, in such a preferred exemplary embodiment a “SMART 2000 Scheduler” can carry out the following tasks:

Detect version of Windows™ and path to Windows™ directory;

Open log;

Get network environment;

Check if computer is connected to company LAN, company VPN, company DUN, an ISPLAN, an ISPDUN or is OFFLINE;

Check if SMART had already run that day, and if not launch SMART and wait until it is finished;

If the computer is connected to a company LAN, VPN or DUN get domain password age (in seconds) if not already queried today;

Calculate any days remaining until a password expires and display a warning if the value is less than 10 (or other system defined number of) days, where such a warning appears independently of the type of connection, but only appears once a day; and

Wait 5 (or other desirable number of) minutes and start the next cycle.

In exemplary embodiments of the present invention, a command line parameter can be used to configure. SMART. Thus, for example, “SMART/config” or “SMART/reset” can display a SMART configuration window and allow a user to reset an initial delay (i.e., a delay on Windows™ 9× systems to avoid timing and performance issues with other starting applications and services) and a client device's home location. It can also reset all SMART settings and cause SMART to redetect all information when SMART gets launched the next time.

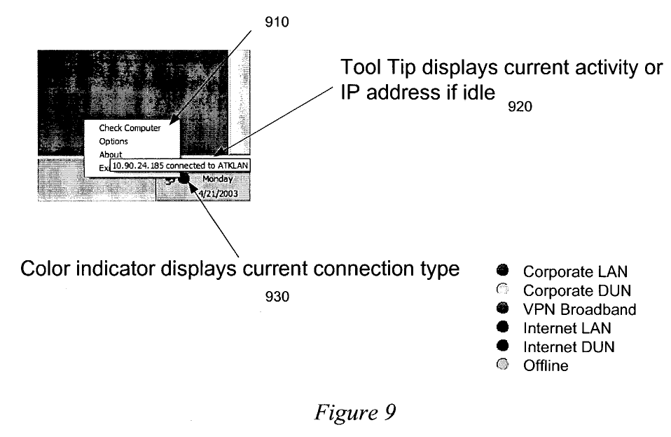

In a preferred exemplary embodiment of the invention, SMART can be located on the Windows™ toolbar, as depicted in the example user interface of FIG. 9. From this toolbar, SMART can provide a visual status indicator and remove any visible script Windows™, etc. A pop-up menu 910 allows a manual computer check, and a tool tip 920 displays current activity or the client's IP address if the client is idle. A color indicator 930 can display the current connection type.

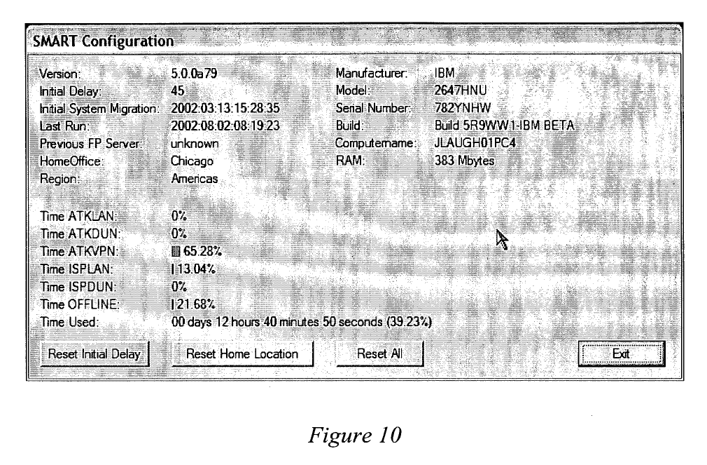

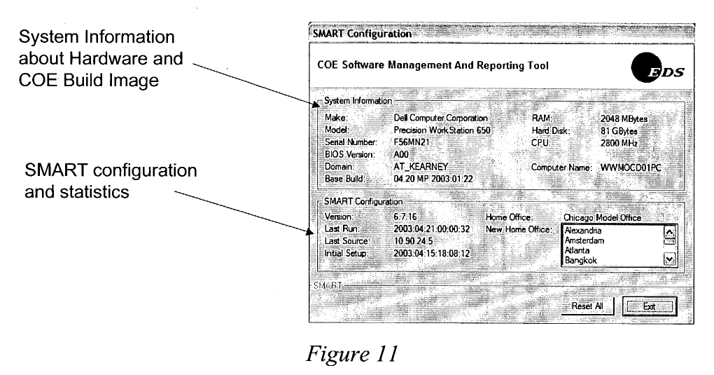

FIG. 10 is an example status window which can be viewed to see a status of SMART's activity, by, for example, right clicking on an icon, or, alternatively, choosing from a pop-up menu. FIG. 11 is an alternate example of such a status window, which additionally displays system information.

Tracking Functionalities

In exemplary embodiments of the present invention advanced support of SQL (or equivalent) database resources can be provided. This allows for the automatic reporting of any data collected via SMART. Information collected by SMART can be sent via email to a dedicated internal address. Then SMART code on a master SMART server can automatically query that mailbox, take the contents of the message and submit that data to a SMART SQL data base.

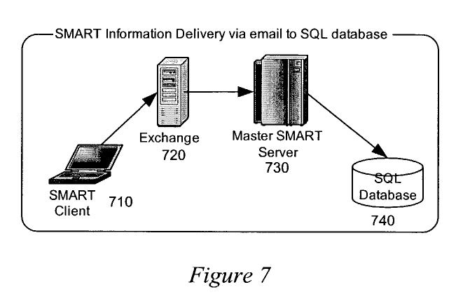

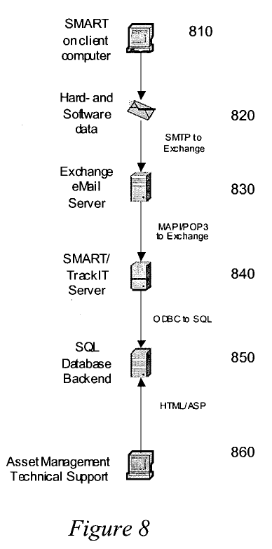

Illustrating this feature, FIGS. 7 and 8 depict an example information transport topology according to an exemplary embodiment of the present invention (FIG. 8 is a more detailed depiction). With reference to these Figures, a SMART client 710, 810 acquires hardware and software data 820 from a client device and sends the data via email, using SMTP, to an Exchange email server 720, 830. The Master SMART server 730, 840 (labeled a “SMART/TrackIT Server” in FIG. 8) reads all incoming emails, then directly inputs the data contained in the email into, for example, an SQL database 740, 850 where it can be accessed by technical support personnel 860 via a Web/HTML based interface.

User and Reporting Interfaces

In preferred exemplary embodiments of the present invention, SMART provides a robust and dynamic asset tracking and management capacity. Each time SMART activates, it can report on essential asset information. As discussed above, this information can be sent to a SMART database application and be made available for reporting and management tasks.

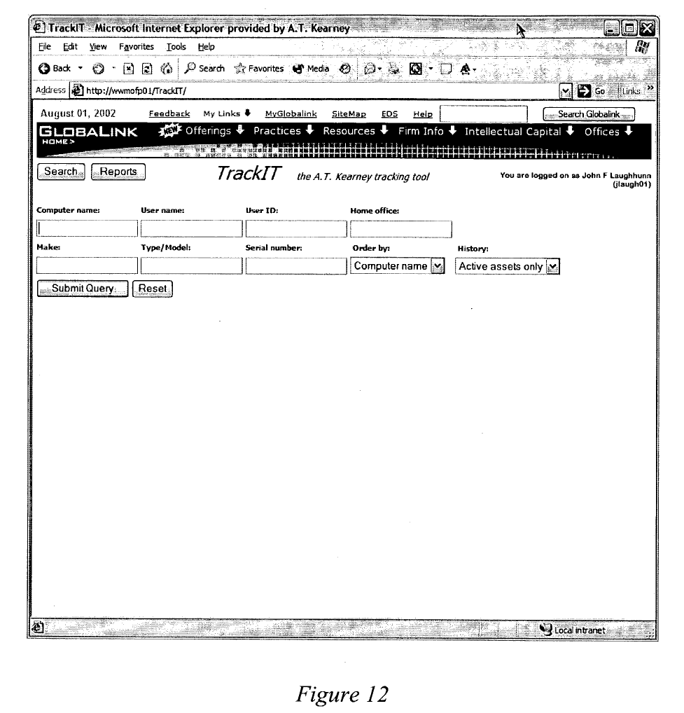

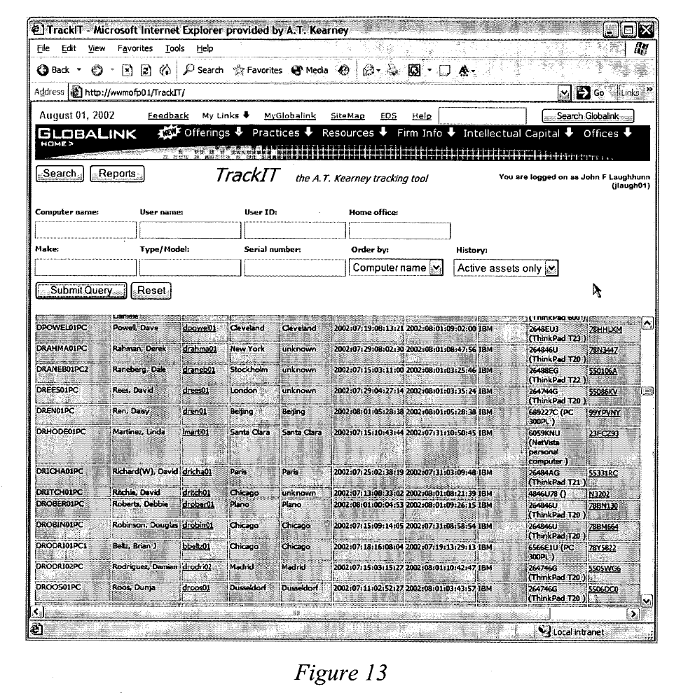

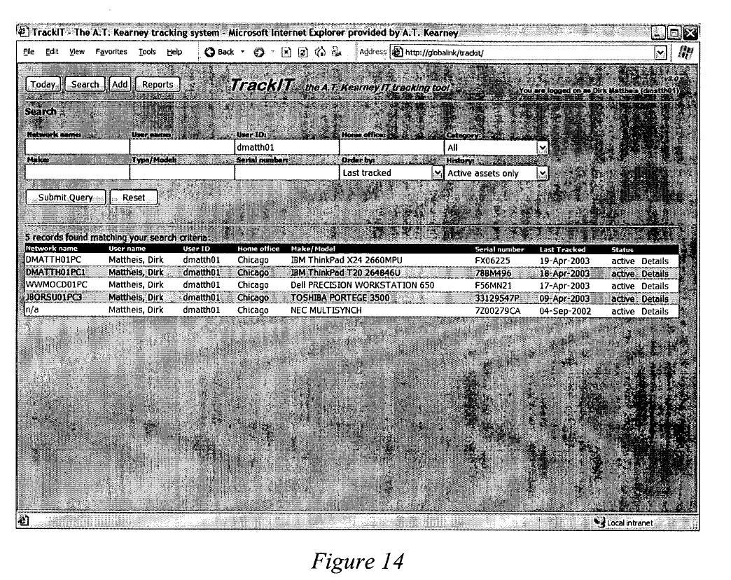

FIG. 12 depicts an exemplary initial search interface to a SMART asset tracking application. In the depicted exemplary embodiment the application has been named “TrackIT” for “tracking information technology.” By entering search criteria on this screen, a user can query information on any asset tracked by SMART. FIG. 13 depicts an exemplary result screen of such a SMART TrackIT asset information query. FIG. 14 depicts another exemplary result screen of such a SMART TrackIT asset information query, where the query was all assets assigned to the User ID “dmatth01.”

Once a desired system as been located, a user can click on either the current user's ID to investigate that user's asset history, or on a system's serial number to track a system history. Initial asset configuration information on a given manufacturer's systems such as, for example, IBM, is dynamically pulled directly via the Internet and that manufacturer's (e.g., IBM's) web site. This ensures that correct initial configurations are recorded, exactly as the client device's manufacturer describes them.

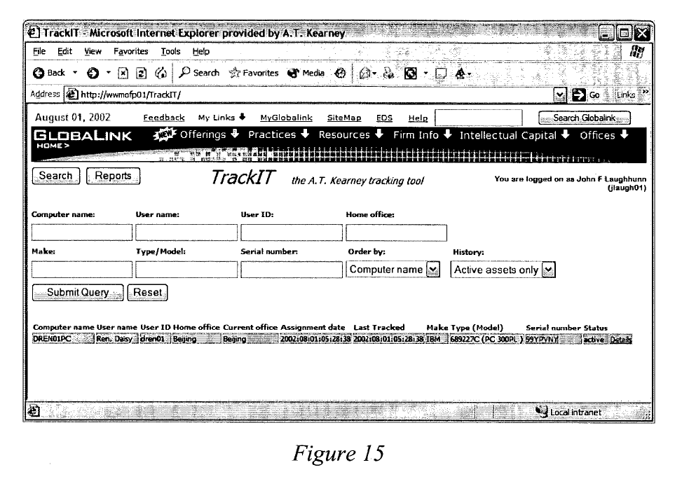

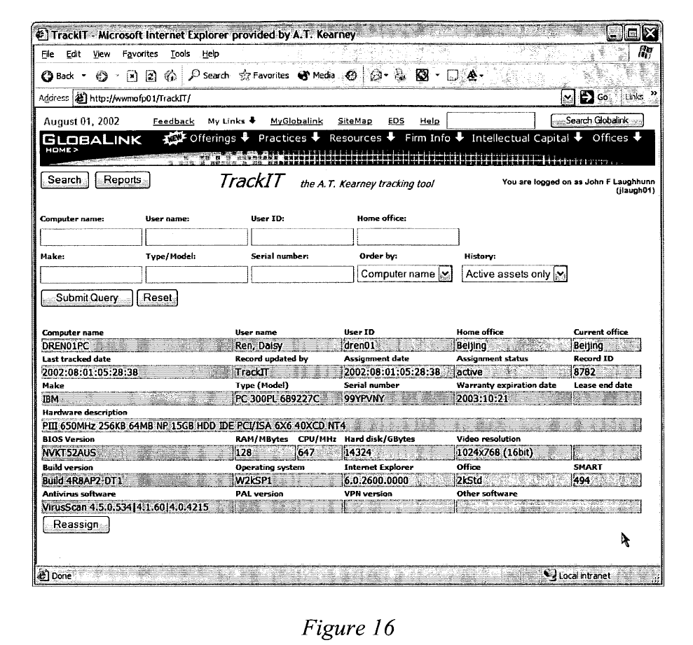

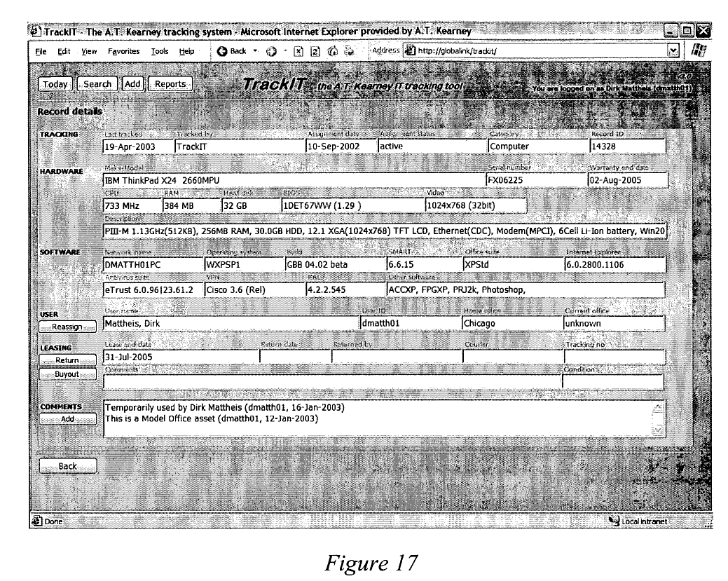

FIG. 15 is an exemplary system detail information screen, where detail can be provided about an asset including fields such as, for example, COMPUTER NAME, USER NAME, USER ID, HOME OFFICE, CURRENT OFFICE, ASSET ASSIGNMENT DATE, LAST TRACKED DATE, MAKE & MODEL, SERIAL NUMBER AND STATUS (active or inactive). In an exemplary embodiment of the present invention a user can click on a DETAILS field of a system detail information screen (shown at the bottom far right in the exemplary screen of FIG. 15) to see an asset information detail screen, such as is depicted in FIG. 16, containing asset information that is pulled interactively from a computer asset's manufacturer (in the depicted example IBM) as well as from data collected by SMART. FIG. 17 depicts another example of such an asset information detail screen.

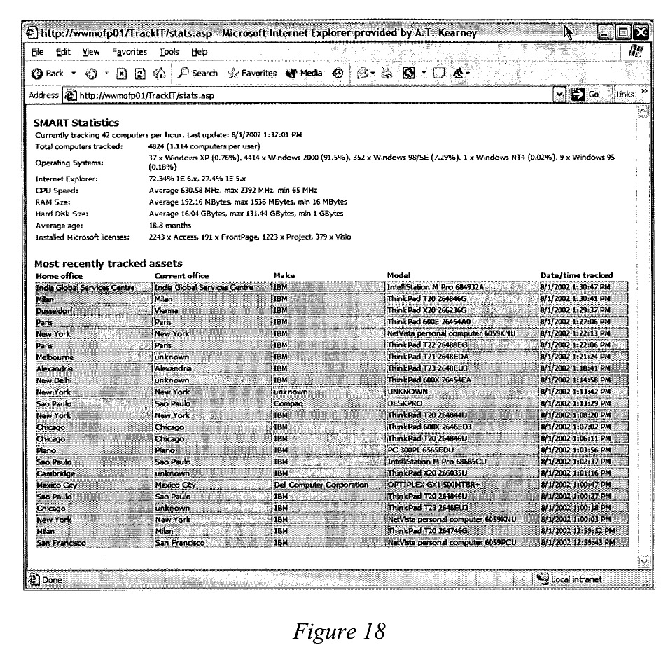

As noted above, SMART can leverage existing messaging infrastructures to dynamically report asset and status information. The example screen in FIG. 18 depicts an actual dynamic report that can be generated from data stored in a SMART SQL asset information data base. Information on this page can be, for example, updated every 10 seconds and can include, for example, the following information:

Asset information for last 25 systems to connect or activate SMART

Home Office, Current Office, Device Manufacturer, Model, Date & Time tracked.

Cumulative information on the following data elements:

Total computers tracked via SMART;

Ratio of computers to users;

Operating Systems present within enterprise (percentage provided);

Internet Explorer version;

CPU Speed (high, low, enterprise average);

RAM Amount (high, low, enterprise average);

Hard Disk Size (high, low, enterprise average);

Average System Age; and

Installed Optional Microsoft Licenses (e.g., Access, FrontPage, Project, Visio).

Such a report interface can, for example, dynamically query three separate data resources, a company asset database located in a data warehouse, a computer manufacturer's (such as, e.g., IBM) hardware web site and a SMART SQL data repository.

SMART Performance Compared With Conventional IT Asset Management Toolsets

SMART can deliver all essential remote management services required to efficiently deploy, manage and operate a highly mobile, highly distributed computing environment. Compared with conventional dedicated server applications, the following advantages of the system and method of the present invention are noted.

SMART requires dramatically less dedicated infrastructure with which to operate. Conventionally available asset management systems require global, regional and a plurality of local dedicated server hardware that must be purchased, maintained and managed.

SMART leverages existing file sharing resources generally already located in a company's facilities, as SMART operates dynamically on a client device.

SMART can automatically determine what type of connection exists to a particular client device and can then dynamically select the proper (i.e., nearest) SMART host resource and activate the most applicable script. Conventional systems have limited dynamic design capacities.

SMART can run “invisibly” from the toolbar and can neither be terminated nor stopped. Should an advanced user terminate SMART, it simply reloads and reactivates. It never “goes away.” Conventional dedicated-server clients can be terminated and uninstalled with much greater ease. When, for example, a Tivoli™ client is active, script activities appear more visibly to user and therefore can be more interruptive and disruptive.

A SMART client has a significantly smaller footprint. Whereas in conventional dedicated-server systems client-side software is often several megabytes. SMART can be implemented in approximately 1 megabyte.

SMART's plug-in architecture makes it easier to distribute new features and functions.

Conventional dedicated-server systems use a single scripting environment that is not as rapidly deployable or safe to deploy as the component plug-in design of SMART.

SMART can be implemented in readily available languages, such as, for example, WinBatch™, Visual Basic, C/C++, etc., leveraging a de facto industry standard that has been established in the industry for many years, and obviating the need for IT personnel to learn a proprietary scripting language. Conventional systems, such as, for example, Tivoli™, have scripting environments that are widely used, but that are also more technical, requiring costly training as well as employee time, etc. to learn.

SMART's hosts can be technology agnostic. SMART shares can be hosted from, for example, Windows™, Unix, Novell or NAS devices. Conventional dedicated server systems require dedicated proprietary software distribution hosts.

Modifications and substitutions by one of ordinary skill in the art are considered to be within the scope of the invention, such as, for example, alternate plug-ins, visual organization of the displayed information, timing between successive SMART cycles, etc. Therefore, the invention is understood not to be limited in any way by the particular examples or exemplary embodiments and methods used herein to describe it. Thus, the scope of the present invention is not to be limited except by the following claims.

What is claimed:

1. A method of remote hardware and software management, comprising:
running management software on a client device which is connected to a computer network;
wherein the management software runs automatically in response to defined events to:
load software updates if available;
execute a series of plug-ins; and
acquire essential asset information.

2. The method of claim 1, where the management software loads software updates by:
determining the location of the client device;
locating a nearest distribution share on the computer network; and
loading software updates from the nearest distribution share.

3. The method of claim 1, wherein the software updates include at least one of updates to the management software and updates to the plug-ins.

4. The method of claim 1, wherein the management software loads software updates from the nearest distribution share via UNC and/or FTP.

5. The method of claim 1, wherein the computer network is one of a company LAN, a company WAN, a company DUN, a VPN, the Internet, or analog remote services.

6. The method of claim 1, further comprising sending the acquired essential asset information to a central server connected to the computer network.

7. The method of claim 6, wherein the acquired essential asset information is automatically input by the central server to a database application and made available for reporting and/or management tasks.

8. The method of claim 6 wherein the essential asset information is sent via email to a dedicated internal address which can be accessed by the central server.

9. The method of claim 1, wherein the management software selectively loads updated software as a function of the type of computer network the client device is connected to.

10. The method of claim 1, wherein the defined events include one or more of a fixed time interval, logon, a change in connectivity, a time stamp of a software application being older than a defined value and an occurrence of a system defined parameter.

11. The method of claim 1, wherein the management software has a modular structure, comprising a core and one or more plug-in modules.

12. The method of claim 1, wherein in operation the management software first executes an update function, and then executes the plug-ins in sequence.

13. The method of claim 2, wherein the management software selectively loads software updates from the nearest distribution share as a function of the client device's operating system and IP address.

14. The method of claim 1, further comprising that if the client device is not connected to a computer network, after a predetermined time the management software displays a prompt on the client device advising a user to connect to a computer network.

15. The method of claim 2, wherein a distribution share can be any device able to share files via UNC and/or FTP.

16. A remote hardware and software management system, comprising:
a management software component installed on a plurality of client devices; and
one or more support servers;
wherein each of the client devices are connected over a computer network to one or more of the support servers,
and wherein the management software component on each client device automatically
locates a nearest support server;
loads updated software if available from the nearest support server; and
runs the updated software on the client device.

17. The system of claim 16, wherein the plurality of client devices comprises one or more of desktop computers, laptop computers, workstations, servers or PDAs.

18. The system of claim 16, wherein the updated software comprises at least one of updates to a management software core and updates to plug-ins.

19. The system of claim 160, wherein the management software component has a modular structure, comprising a core with one or more plug-ins.

20. The system of claim 16, wherein when the management software component loads updated software from the nearest server, it selectively loads software specific to the client device.

21. The system of claim 16, wherein the computer network is one of a company LAN, a company WAN, a company DUN, a VPN, the Internet or analog remote services.

22. The system of claim 16, wherein the management software selectively loads different updated software from the nearest server depending upon the type of computer network over which the client device is connected to the nearest server.

23. The system of claim 16, wherein the management software selectively loads different updated software from the nearest server depending upon the type of client device and depending upon client device specific criteria.

24. The system of claim 16, wherein the one or more support servers can be distributed or centralized.

25. The system of claim 16, wherein a support server comprises at least one of existing file/print servers running on a LAN, secure FTP servers hosted inside a company LAN environment and secure FTP servers hosted outside a corporate LAN environment.

26. The system of claim 16, further comprising a master system server which distributes software to the one or more support servers.

27. The system of claim 16, wherein the management software additionally acquires essential asset information.

28. The system of claim 27, further comprising a database application running on a master system server, wherein the essential asset information is sent to the master system server and input to the database application for use in reporting and/or management tasks.
